(19) United States
(12) Patent Application Publication
(10) Pub. No.: US 2006/0276130 A1
(43) Pub. Date: Dec. 7, 2006

(54) Device, system and method of reduced power consumption multi-receiver

(76) Inventor: Shai Waxman, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/141,333

(22) Filed: Jun. 1, 2005

(51) Int. Cl. H04B 7/14

(52) U.S. Cl. 455/41.2; 455/69

(57) ABSTRACT

Briefly, some embodiments of the invention provide devices, systems and methods to conserve power consumed by multi-receivers. For example, a method in accordance with an embodiment of the invention may include setting an operational parameter of one or more receivers of a multi-receiver configuration based on a physical transfer rate requirement.

### BACKGROUND OF THE INVENTION

In the field of wireless communications, a first wireless communication station may include multiple transceivers able to communicate, for example, with a second wireless communication station or a wireless access point. Multi-transceiver communication may be, for example, in accordance with Institute of Electrical and Electronics Engineers (IEEE) 802.11n standard, and may result in significant power consumption.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system able to selectively activate and deactivate one or more receivers in accordance with an embodiment of the invention; and

FIG. 2 is a schematic flow-chart of a method of selectively activating and deactivating one or more receivers in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this regard, embodiments of the invention may be used in conjunction with many apparatuses, for example, a transmitter, a receiver a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a Personal Digital Assistant (PDA) device, a tablet computer, a server computer, a network, a wireless network, a Local Area Network (LAN), a Wireless LAN (WLAN), devices and/or networks operating in accordance with existing IEEE 802.11, 802.11a, 802.11b, 802.11e, 802.11g, 802.11h, 802.11i, 802.11n, 802.16 standards and/or future versions of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. It is noted that embodiments of the invention may be used in various other apparatuses, devices, systems and/or networks.

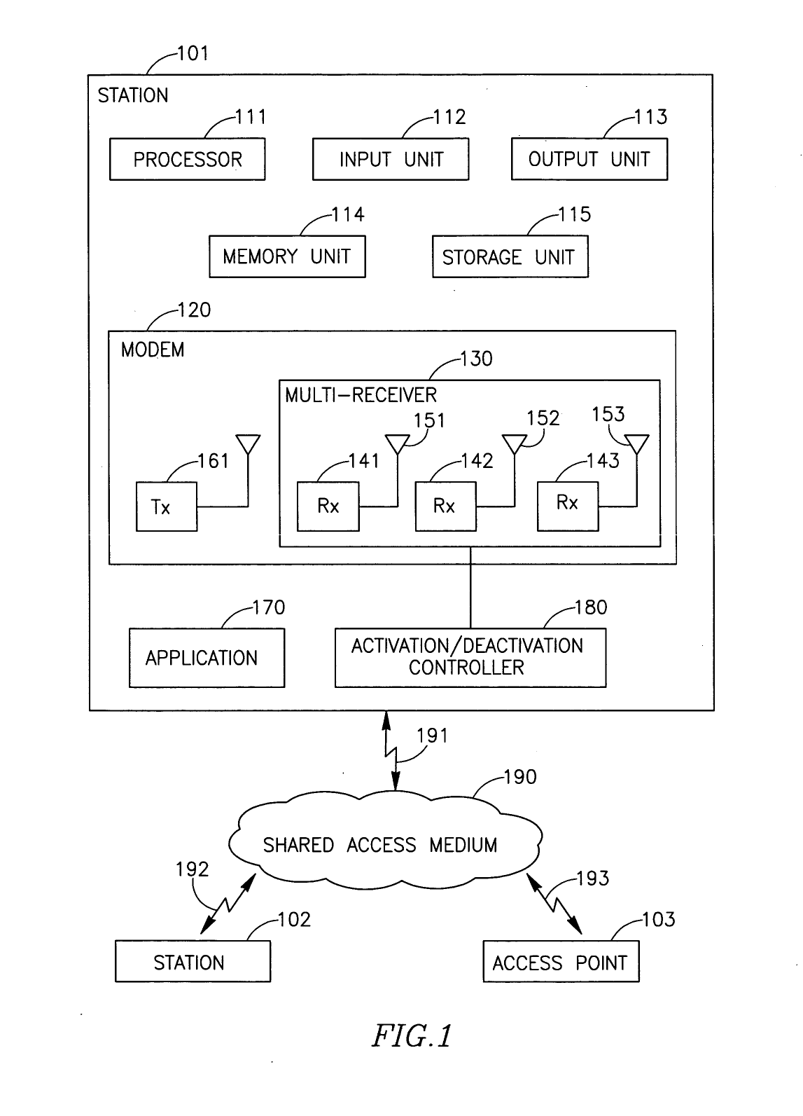

FIG. 1 schematically illustrates a block diagram of a wireless communication system 100 able to selectively activate and deactivate one or more receivers in accordance with an embodiment of the invention. System 100 may include one or more wireless communication stations, e.g., stations 101 and 102, and one or more wireless access points, erg., access point 103. Station 101, station 102 and access point 103 may communicate using a shared access medium 190, for example, through wireless communication links 191, 192 and 193, respectively.

Station 101 may include, for example, a processor 111, an input unit 112, an output unit 113, a memory unit 114, a storage unit 115, and a modem 120. Station 101 may further include other hardware components and/or software components.

Processor 111 may include, for example, a Central Processing Unit (CPU), a Digital Signal Processor (DSP), a microprocessor, a controller, a chip, a microchip, an Integrated Circuit (IC), or any other suitable multi-purpose or specific processor or controller

Input unit 112 may include, for example, a keyboard, a keypad, a mouse, a touch-pad, or other suitable pointing device or input device. Output unit 113 may include, for example, a Cathode Ray Tube (CRT) monitor or display unit, a Liquid Crystal Display (LCD) monitor or display unit, or other suitable monitor or display unit.

Memory unit 114 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

Storage unit 115 may include, for example, a hard disk drive, a floppy disk drive, a Compact Disk (CD) drive, a CD-ROM drive, or other suitable removable or non-removable storage units.

Modem 120 may include, for example, a wireless modem having, for example, a wireless transmitter 161 and a wireless multiple-receiver 130. Transmitter 161 may include, for example, a Radio Frequency (RF) transmitter able to transmit RF signals, e.g., through an antenna 162. Multiple-receiver 130 may include, for example, multiple receivers 141, 142 and 143 able to transmit RF signals, e.g., through multiple antennas 151, 152 and 153, respectively.

In some embodiments, transmitter 161 and multiple-receiver 130 may be implemented as a transceiver, a transmitter-receiver, or one or more units able to perform separate or integrated functions of sending and/or receiving wireless communication signals, blocks, frames, transmission streams, packets, messages and/or data.

Antenna 162, antenna 151, antenna 152 and/or antenna 153 may include an internal and/or external RF antenna, for example, a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, transmission streams, packets, messages and/or data.

In some embodiments, an application 170 may be executed by station 101. The application 170 may include, for example, a software application, an Operating System (OS), a communications driver, or the like. The application 170 may require station 101 to receive wireless communication signals at a minimum physical transfer rate (referred to herein as “application minimum PHY rate”), for example, to maintain a certain Quality of Service (QoS) level which may be required by the application 170.

In some embodiments, the access point 103 or other component of the system 100 may require station 101 to receive wireless communication signals at a minimum physical transfer rate (referred to herein as “AP/network minimum PHY rate”), for example, to maintain a certain QoS level which may be required by the access point 103 and/or by the system 100.

In accordance with some embodiments of the invention, station 101 may selectively activate or deactivate one or more of receivers 141-143, or may otherwise set or modify their operational status or operational parameter, in relation to the application minimum PHY rate and/or the AP/network minimum PHY rate, in relation to the greater of the application minimum PHY rate and the AP/network minimum PHY rate (referred to herein as “the greater minimum PHY rate”), or in relation to other PHY rate requirement.

In some embodiments, the selective activation and/or deactivation of receivers 141-143 may be performed, for example, by an activator/deactivator 180 which may be implemented as, for example, a sub-unit of station 101, a sub-unit of processor 111, a sub-unit of modem 120, a sub-unit of receiver 130, a controller, an activation controller, a deactivation controller, an activation/deactivation controller or unit, or other hardware component and/or software component.

In some embodiments, for example, the activator/deactivator 180 may selectively activate or deactivate one or more of receivers 141-143, to allow station 101 to receive wireless communication signals at a minimum physical transfer rate which may be equal to the greater minimum PHY rate. In some embodiments, the activator/deactivator 180 may selectively set or modify an operational status, e.g., active or non-active status, or an operational parameter of one or more of receivers 141-143, to allow station 101 to receive wireless communication signals at a minimum physical transfer rate which may be equal to the greater minimum PHY rate.

In some embodiments, for example, receiver 141, receiver 142 and receiver 143 may be able to receive wireless communication signals at a certain physical transfer rate, e.g., 54 Megabits per second (Mbps) In one embodiment, the activator/deactivator 180 may determine that the greater minimum PHY rate is, for example, 40 Mbps, and therefore the activator/deactivator 180 may activate receiver 141 and may deactivate receivers 142 and 143. In another embodiment, the activator/deactivator 180 may determine that the greater minimum PHY rate is, for example, 80 Mbps, and therefore the activator/deactivator 180 may activate receivers 141 and 142 and may deactivate receiver 143. In yet another embodiment, the activator/deactivator 180 may determine that the greater minimum PHY rate is, for example, 140 Mbps, and therefore the activator/deactivator 180 may activate receivers 141-143. In still another embodiment, the activator/deactivator 180 may determine that no Transport Stream (TS) is established between the station 101 and the access point 103, and the activator/deactivator 180 may activate only receiver 141 and maintain the receivers 142 and 143 deactivated

In some embodiments, the activator/deactivator 180 may monitor changes in the application minimum PHY rate (e.g., resulting from changes in the application 170 requirements), changes in the AP/network minimum PHY rate (e.g., resulting from changes in network conditions in system 100), or changes in the greater minimum PHY rate (e.g., resulting from changes in the application minimum PHY rate and/or the AP/network minimum PHY rate). Based on such changes, e.g., based on changes in the greater minimum PHY rate, the activator/deactivator 180 may selectively activate or deactivate one or more of receivers 141-143.

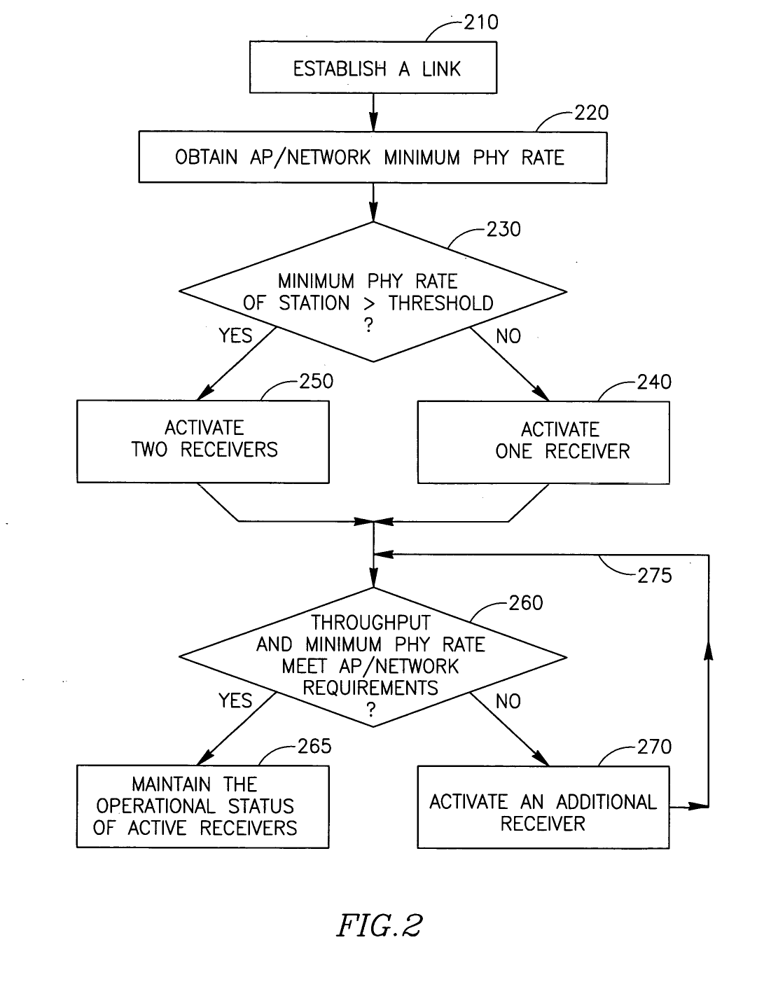

FIG. 2 is a schematic flow-chart of a method of selectively activating and deactivating one or more receivers in accordance with an embodiment of the invention. Operations of the method may be implemented, for example, by system 100 of FIG. 1, by station 101 of FIG. 1, by station 102 of FIG. 1, by access point 103 of FIG. 1, by processor 111 of FIG. 1, by modem 120 of FIG. 1, by receiver 130 of FIG. 1, by activator/deactivator 180, and/or by other suitable stations, access points, controllers, modems, processors, units, devices, and/or systems.

As indicated at box 210, the method may include, for example, establishing a wireless communication link, e.g., between a wireless communication station and a wireless access point.

As indicated at box 220, the method may optionally include, for example, obtaining a value of an AP/network minimum PHY rate, e.g., as provided or calculated by the access point. In some embodiments, for example, the AP/network minimum PHY rate may be included in a dedicated field or parameter sent by the access point, e.g., “MIN_PHY_RATE” field. In some embodiments, the AP/network minimum PHY rate may be obtained from data received by the station in Traffic Specification (TSPEC) exchange of data, or through higher layers in the communication exchange.

As indicated at box 230, the method may include, for example, checking whether the minimal physical rate of a Transport Stream (TS) of the station is greater than a pre-defined threshold, e.g., 54 Mbps.

As indicated at box 240, if the checking result is negative, then the method may include, for example, selectively activating one receiver. This may include, for example, deactivating substantially all receivers that may be active except for one receiver, or activating one receiving and maintaining other receivers deactivated.

Alternatively, as indicated at box 250, if the checking result is positive, then the method may include, for example, selectively activating multiple receivers, e.g., two receivers. This may include, for example, deactivating substantially all receivers that may be active except for two receivers, or selectively activating two receivers and maintaining other receivers deactivated.

As indicated at box 260, the method may include, for example, checking whether the throughput and/or the minimum physical transfer rate of the station meet and requirements of an application and, optionally, the requirements of the access point and/or network. In some embodiments, for example, this may include checking whether the minimum physical transfer rate or the station is equal to the greater minimum PHY rate.

As indicated at box 265, if the checking result is positive, then the method may include, for example, maintaining the operational status of currently activated receiver(s) without activating additional receiver(s).

Alternatively, as indicated at box 270, if the checking result is negative, then the method may include, for example, selectively activating an additional receiver, e.g., if the station includes an additional receiver which may be activated. Then, as indicated by arrow 275, the method may include repeating the check of box 270.

In some embodiments, the check of box 270 may be performed, for example, periodically, upon a user demand, upon an application demand, upon an access point demand, continuously, substantially continuously, in pre-defined time intervals, or the like.

Some embodiments of the invention may use other suitable operations to dynamically change the number of active receivers, e.g., in a multi-receiver or multi radio device, based on one or more criteria, for example, required throughput, required QoS, application minimum PHY rate, AP/network minimum PHY rate, the greater of the application minimum PHY rate and the AP/network minimum PHY rate, or the like.

Other suitable operations or sets of operations may be used in accordance with embodiments of the invention.

Although portions of the discussion herein may relate, for exemplary purposes, to activating and deactivating a receiver of a multi-receiver, embodiments of the invention are not limited in this regard, and may include, for example, activating and deactivating a transmitter of a multi-transmitter, activating and deactivating a transceiver of a multi-transceiver, or the like.

Although portions of the discussion herein may relate, for exemplary purposes, to activating and deactivating (e.g., a receiver), embodiments of the invention are not limited in this regard, and may include, for example, modifying or setting an operational status, modifying or setting an operational parameter, turning on, turning off, bringing into or out of a stand-by mode, bringing into or out of a “sleep” mode, or the like. In some embodiments, for example, activating a receiver may include supplying power to the receiver or increasing the power supplied to a receiver, and deactivating a receiver may include disconnecting the receiver from a power source or reducing power supplied to the receiver.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention ma)y be implemented, for example, using a machine-readable medium or article which may store an instruction or a set of instructions that, if executed by a machine, for example, by system 100 of FIG. 1, by station 101 of FIG. 1, by station 102 of FIG. 1, by access point 103 of FIG. 1, by processor 111 of FIG. 1, by modem 120 of FIG. 1, by receiver 130 of FIG. 1, by activator/deactivator 180 of FIG. 1, or b) other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using an), suitable combination of hardware and/or software. The machine-readable medium or article may include, for example, any suitable type of memory unit (e.g., memory unit 114 or storage unit 115), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
setting an operational parameter of one or more receivers of a multi-receiver configuration based on a physical transfer rate requirement.

2. The method of claim 1, wherein setting said operational parameter comprises:
selectively activating at least one receiver of said multi-receiver configuration.

3. The method of claim 1, wherein setting said operational parameter comprises:
selectively deactivating at least one receiver of said multi-receiver configuration

4. The method of claim 1, wherein setting said operational parameter comprises:
setting said operational parameter based on a physical transfer rate required by an access point in communication with said multi-receiver configuration.

5. The method of claim 1, wherein setting said operational parameter comprises:
setting said operational parameter based on a physical transfer rate required by an application executed by a device associated with said multi-receiver configuration.

6. The method of claim 1, wherein setting said operational parameter comprises:
setting said operational parameter to the greater of a physical transfer rate required by an application executed by a device associated with said multi-receiver configuration and a physical transfer rate required by an access point in communication with said multi-receiver configuration

7. The method of claim 1, wherein setting said operational parameter comprises:
if a value of said minimum physical transfer rate parameter does not meet a requirement set by an access point in communication with said multi-receiver configuration, activating an additional receiver of said multi-receiver configuration.

8. The method of claim 1, wherein setting comprises:
if a value of said,.minimum physical transfer rate parameter does not meet a requirement set by an application executed by a device associated with said multi-receiver configuration, activating an additional receiver of said multi-receiver configuration.

9. An apparatus comprising:
an activation controller to set an operational parameter of one or more receivers of a multi-receiver configuration based on a physical transfer rate requirement.

10. The apparatus of claim 9, wherein said activation controller is to selectively activate at least one receiver of said multi-receiver configuration based on said physical transfer rate requirement.

11. The apparatus of claim 9, wherein said activation controller is to selectively deactivate at least one receiver of said multi-receiver configuration based on said physical transfer rate requirement.

12. The apparatus of claim 9, wherein said activation controller is to set said operational parameter based on a physical transfer rate required by an access point in communication with said multi-receiver configuration.

13. The apparatus of claim 9, wherein said activation controller is to set said operational parameter based on a physical transfer rate required by an application executed by a device associated with said multi-receiver configuration.

14. The apparatus of claim 9, wherein said activation controller is to set said operational parameter to tile greater of a physical transfer rate required by an application executed by a device associated with said multi-receiver configuration and a physical transfer rate required by an access point in communication with said multi-receiver configuration.

15. The apparatus of claim 9, wherein said activation controller is to activate an additional receiver of said multi-receiver configuration if a value of said minimum physical transfer rate parameter does not meet a requirement set by an access point in communication with said multi-receiver configuration.

16. The apparatus of claim 9, wherein said activation controller is to activate an additional receiver of said multi-receiver configuration if a value of said minimum physical transfer rate parameter does not meet a requirement set by an application executed by a device associated with said multi-receiver configuration.

17. The apparatus of claim 97 comprising said multi-receiver configuration to receive wireless communication signals.

18. A wireless communication device comprising:
a dipole antenna to receive wireless communication signals; and
an apparatus according to claim 9.

19. A wireless communication device comprising:
a dipole antenna to receive wireless communication signals; and
an apparatus according to claim 10.

20. A wireless communication device comprising:
a dipole antenna to receive wireless communication signals; and
an apparatus according to claim 11.

21. A wireless communication system comprising:
a wireless communication station having an activation controller to set an operational parameter of one or more receivers of a multi-receiver configuration based on a physical transfer rate requirement.

22. The wireless communication system of claim 21, wherein said activation controller is to selectively activate at least one receiver of said multi-receiver configuration.

23. The wireless communication system of claim 21, wherein said activation controller is to selectively deactivate at least one receiver of said multi-receiver configuration.

24. The wireless communication system of claim 21, wherein said wireless communication station is to execute an application, and wherein said physical transfer rate requirement is provided by said application.

25. The wireless communication system of claim 21, further comprising:
an access point in communication with said wireless communication station to provide said physical transfer rate requirement.

26. The wireless communication system of claim 25, wherein said activation controller is to set said operational parameter to the greater of a physical transfer rate required by an application to be executed by said wireless communication station and a physical transfer rate requirement provided by said access point.

27. A machine-readable medium having stored thereon a set of instructions that, if executed by a machine, cause the machine to perform a method comprising:
setting an operational parameter of one or more receivers of a multi-receiver configuration based on a physical transfer rate requirement.

28. The machine-readable medium of claim 27, wherein the instructions result in:
selectively activating at least one receiver of said multi-receiver configuration.

29. The machine-readable medium of claim 27, wherein the instructions result in:
selectively activating at least one receiver of said multi-receiver configuration.
